(19) United States
(12) Patent Application Publication
(10) Pub. No.: US 2026/0327054 A1
(43) Pub. Date: Oct. 22, 2026

(54) MULTIFUNCTION PRY BAR

(71) Applicant: Christopher Kuras, Wilton Manors, FL (US)

(72) Inventor: Christopher Kuras, Wilton Manors, FL (US)

(21) Appl. No.: 19/648,864

(22) Filed: Apr. 15, 2026

Related U.S. Application Data
(60) Provisional application No. 63/789,513, filed on Apr. 16, 2025.

(51) Int. Cl. B66F 15/00; A62B 3/00; B25F 1/00

(52) U.S. Cl. CPC B66F 15/00; A62B 3/005; B25F 1/006

(57) ABSTRACT

A multifunction pry bar includes a shank having a first end and a second end, a wedge portion extending from the first end of the shank, and a head portion extending from the second end of the shank. The head portion includes a tapered pick, a finger choil disposed adjacent to the second end of the shank, and a serrated cutting edge extending between the tapered pick and the finger choil. The serrated cutting edge may be curved, and the wedge portion may include a notch at its free end. In some implementations, the shank may include a plurality of lightening cutouts formed therein.

### CROSS-REFERENCE TO RELATED APPLICATIONS

This application claims the benefit of U.S. Provisional Application Serial No. 63/789,513, filed on Apr. 16, 2025, the entirety of which is incorporated herein by reference.

### TECHNICAL FIELD

This disclosure relates to hand tools, and specifically to multifunction pry bars configured for tactical and emergency use.

### BACKGROUND

Pry bars and other forcible-entry tools are used in a variety of military, law-enforcement, rescue, and emergency-response environments. In many such environments, users may need to carry a compact hand tool capable of performing multiple functions, such as prying, puncturing, and cutting, while remaining readily accessible on a vest, belt, pack, or other item of tactical or emergency-response equipment.

### SUMMARY

It is to be understood that this summary is not an extensive overview of the disclosure. This summary is exemplary and not restrictive, and it is intended neither to identify key or critical elements of the disclosure nor to delineate the scope thereof. The sole purpose of this summary is to explain and exemplify certain concepts of the disclosure as an introduction to the following complete and detailed description.

Implementations of a multifunction pry bar are disclosed. The multifunction pry bar includes features that enhance functionality during tactical and emergency operations.

In one example implementation, a tool comprises a shank having a first end and a second end, a wedge portion extending from the first end of the shank, and a head portion extending from the second end of the shank. The head portion includes a tapered pick, a finger choil disposed adjacent to the second end of the shank, and a serrated cutting edge extending between the tapered pick and the finger choil.

In another example implementation, a tool comprises a shank having a first end and a second end, a wedge portion extending from the first end of the shank, a head portion extending from the second end of the shank, and a plurality of lightening cutouts formed in at least one of the shank and the head portion. The head portion includes a tapered pick, a finger choil disposed adjacent to the second end of the shank, and a serrated cutting edge extending between the tapered pick and the finger choil.

In yet another example implementation, a tool comprises a shank having a first end and a second end, a wedge portion extending from the first end of the shank, a head portion extending from the second end of the shank, and a cutting element disposed in the shank. The head portion includes a tapered pick, a finger choil disposed adjacent to the second end of the shank, and a serrated cutting edge extending between the tapered pick and the finger choil.

In still another example implementation, a tool comprises a shank having a first end and a second end, a wedge portion extending from the first end of the shank, and a head portion extending from the second end of the shank. The head portion includes a tapered pick, an axe blade, and a first serrated cutting edge extending from the tapered pick toward the second end of the shank.

Any of the implementations herein, wherein the serrated cutting edge is curved.

Any of the implementations herein, wherein the shank includes a front edge and a rear edge, and each of the front edge and the rear edge includes a knurled portion.

Any of the implementations herein, wherein the shank and the wedge portion have substantially the same width.

Any of the implementations herein, wherein the tapered pick terminates in a pointed tip.

Any of the implementations herein, wherein the head portion includes a contact face positioned opposite the tapered pick.

Any of the implementations herein, wherein the finger choil is a curved indentation.

Any of the implementations herein, wherein the tool is formed as a single piece.

Any of the implementations herein, wherein the lightening cutouts are formed in both the shank and the head portion.

Any of the implementations herein, further comprising at least one bore extending through at least one of the shank and the head portion.

Any of the implementations herein, wherein the wedge portion includes a notch at a free end thereof.

Any of the implementations herein, wherein the notch is generally V-shaped.

Any of the implementations herein, wherein the wedge portion is angled away from a longitudinal axis of the shank.

Any of the implementations herein, wherein the cutting element includes an edge accessible through a slot formed in the shank.

Any of the implementations herein, further comprising a glass breaker disposed on the head portion.

Any of the implementations herein, wherein the axe blade is positioned opposite the tapered pick.

Any of the implementations herein, wherein the axe blade includes a cutting edge and a second serrated cutting edge disposed along an underside of the axe blade.

Any of the implementations herein, wherein the cutting edge of the axe blade is blunt.

Any of the implementations herein, wherein the second serrated cutting edge is configured to ease withdrawal of the tool from a cut.

Any of the implementations herein, wherein the head portion further includes a choil.

Any aspect of any implementation may be combined with any one or more aspects of any other implementation(s).

Any one or more of the features disclosed herein may be used alone or in combination.

Any one or more of the features as substantially disclosed herein.

Any one or more of the features as substantially disclosed herein, in combination with any one or more other features as substantially disclosed herein.

Any one of the aspects, features, or implementations, in combination with any one or more other aspects, features, or implementations.

Use of any one or more of the aspects or features disclosed herein.

It should be appreciated that any feature described herein can be claimed in combination with any one or more other features described herein, regardless of whether the features originate from the same described implementation.

The details of one or more aspects of the disclosure are set forth in the accompanying drawings and the description below. Other features, objects, and advantages of the techniques described in this disclosure will be apparent from the description and drawings, and from the claims.

Numerous additional features and advantages of the present disclosure will become apparent to those skilled in the art upon consideration of the implementation descriptions provided below.

Additional features and advantages are described herein and will be apparent from the following description and figures.

### BRIEF DESCRIPTION OF THE DRAWINGS

FIG. 1 is a perspective view of a multifunction pry bar according to the principles of the present disclosure.

FIG. 2 is another perspective view of the multifunction pry bar shown in FIG. 1.

FIG. 3 is a top plan view of the multifunction pry bar shown in FIG. 1.

FIG. 4 is a perspective view of another multifunction pry bar according to the principles of the present disclosure.

FIG. 5 is another perspective view of the multifunction pry bar shown in FIG. 4.

FIG. 6 is a top plan view of the multifunction pry bar shown in FIG. 4.

FIG. 7 is a perspective view of yet another multifunction pry bar according to the principles of the present disclosure.

FIG. 8 is another perspective view of the multifunction pry bar shown in FIG. 7.

FIG. 9 is a top plan view of the multifunction pry bar shown in FIG. 7.

FIG. 10 is an exploded view of the multifunction pry bar shown in FIG. 7.

FIG. 11 is a perspective view of still another multifunction pry bar according to the principles of the present disclosure.

FIG. 12 is another perspective view of the multifunction pry bar shown in FIG. 11.

FIG. 13 is a top plan view of the multifunction pry bar shown in FIG. 11.

FIG. 14 is an exploded view of the multifunction pry bar shown in FIG. 11.

Like reference numerals refer to corresponding parts throughout the several views of the drawings.

### DETAILED DESCRIPTION

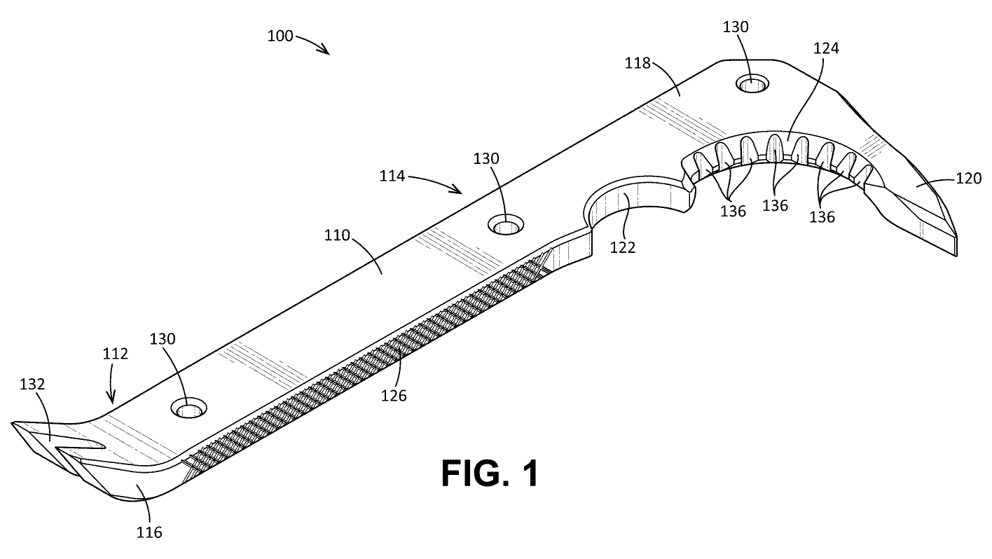

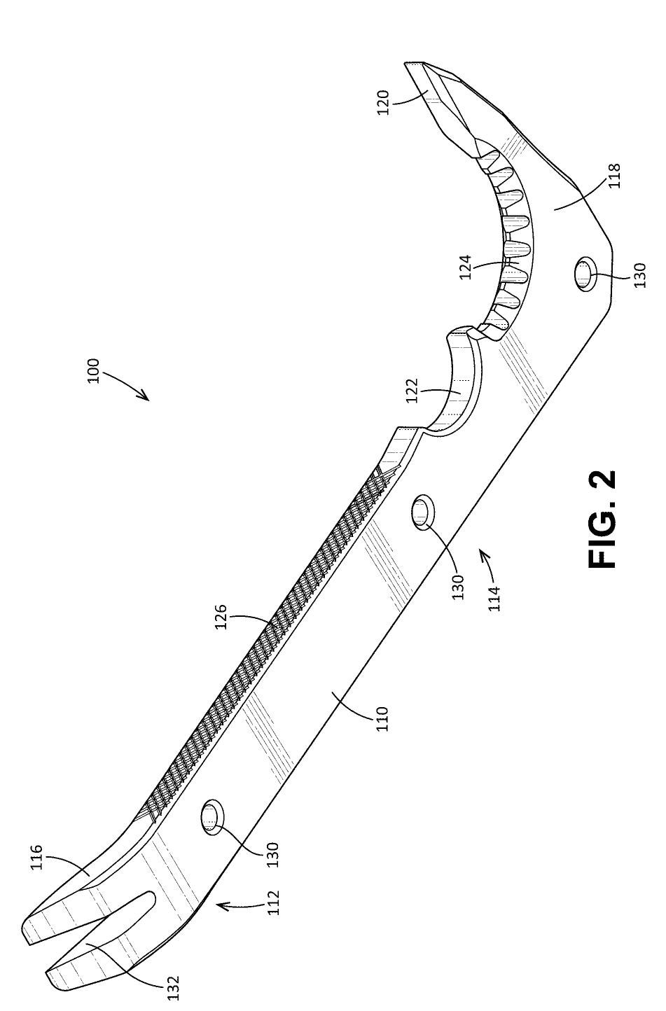

FIGS. 1–3 illustrate a multifunction pry bar 100 according to the principles of the present disclosure. The multifunction pry bar 100 includes a combination of features that enhance functionality during tactical and emergency operations.

The multifunction pry bar 100 comprises a substantially straight shank 110 having a first end 112 and a second end 114. A wedge portion 116 extends from the first end 112 of the shank 110, and a head portion 118 extends from the second end 114 of the shank 110. The head portion 118 includes a tapered pick 120, a finger choil 122 positioned adjacent to the second end 114 of the shank 110, and a curved, serrated cutting edge 124 extending between the tapered pick 120 and the finger choil 122.

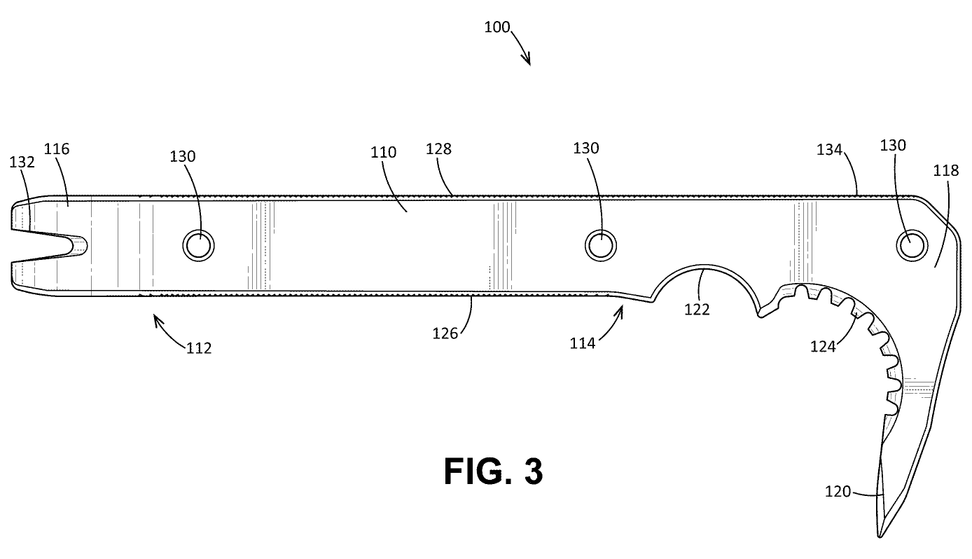

The shank 110 of the multifunction pry bar 100 includes a front edge 126 and a rear edge 128, each of which is knurled. The knurling is provided to improve grip during use. As shown in FIG. 3, the shank 110 may have a width of approximately 1 inch (e.g., about 27 mm) at its widest point. The shank 110 and the wedge portion 116 of the multifunction pry bar 100 have substantially the same width, which may allow the multifunction pry bar 100 to be inserted through Pouch Attachment Ladder System (PALS) slots or PALS-compatible openings, such as those found on modular tactical gear.

The wedge portion 116 of the multifunction pry bar 100 extends from the first end 112 of the shank 110 and includes a notch 132 at its free end. The notch 132 is generally V-shaped and is configured to assist in prying open closed doors. The wedge portion 116 is curved or angled away from the longitudinal axis of the shank 110 to improve prying leverage and forms an angle of approximately 55 degrees relative to the longitudinal axis at its free end. In other implementations, the angle of the wedge portion 116 may be greater than or less than 55 degrees. The wedge portion 116 has a width of approximately 1 inch (e.g., about 27 mm). In other implementations, the wedge portion 116 may have a width that is less than or greater than about 27 mm. During use, the wedge portion 116 may be inserted between two objects, such as a door and a doorjamb, and the shank 110 may be leveraged to pry the objects apart.

The head portion 118 of the multifunction pry bar 100 extends from the second end 114 of the shank 110 and includes a tapered pick 120 for penetrating building materials, breaking locks, and opening doors. The tapered pick 120 terminates in a pointed tip and has a gradually narrowing profile along its length to concentrate force and enable efficient entry into a workpiece. During use, the tapered pick 120 may be positioned against a surface to be penetrated, and the opposite side of the head portion 118, which serves as a contact face 134, may be struck by a hammer or other striking tool. The impact may drive the tapered pick 120 into the workpiece, allowing it to breach, puncture, or weaken the material.

The head portion 118 also includes a curved, serrated cutting edge 124 and a finger choil 122. The serrated cutting edge 124 extends between the tapered pick 120 and the finger choil 122 along a curved region of the head portion 118. The serrations 136 are configured to cut through materials such as laminated glass, plastic, and fibrous composites, and are shaped to provide aggressive cutting performance while minimizing the likelihood of snagging. In some implementations, the geometry and spacing of the serrations 136 may be configured to reduce unintended contact-related injury during transport, storage, and use. The serrated cutting edge 124 may include eight serrations 136 defined by notches along the curved region of the head portion 118. The number, spacing, and shape of the serrations 136 may vary in other implementations depending on the desired cutting performance and material application. The finger choil 122 is a curved indentation formed in the head portion 118 adjacent to the second end 114 of the shank 110. The finger choil 122 may be shaped to receive a user’s index finger, thereby enhancing grip, control, and safety during manipulation of the multifunction pry bar 100, particularly during use of the serrated cutting edge 124.

The multifunction pry bar 100 may also include three bores 130, each extending through the multifunction pry bar 100 to reduce weight. Two of the bores 130 are located in the shank 110: one adjacent to the first end 112 and one adjacent to the second end 114. The third bore 130 is located in the head portion 118. The bores 130 may be distributed along the longitudinal axis of the multifunction pry bar 100. In other implementations, the multifunction pry bar 100 may include more or fewer than three bores 130.

The multifunction pry bar 100 may be formed as a single piece from steel, such as 410HC stainless steel, or from other suitable materials, including titanium alloys. The material may be selected based on factors such as strength, corrosion resistance, weight, and intended use. In some implementations, the multifunction pry bar 100 may be formed by forging, machining, or other suitable fabrication techniques.

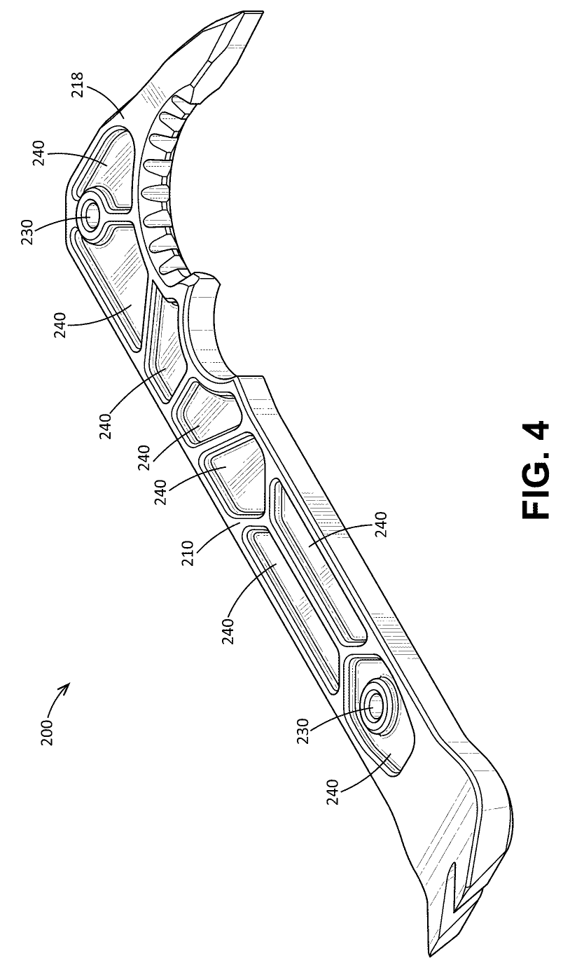

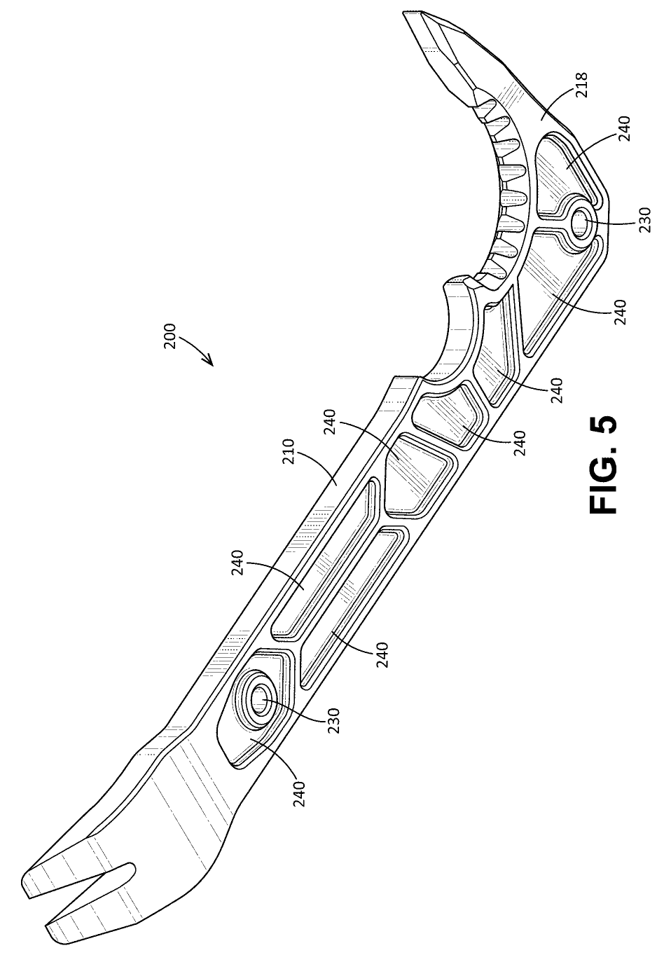

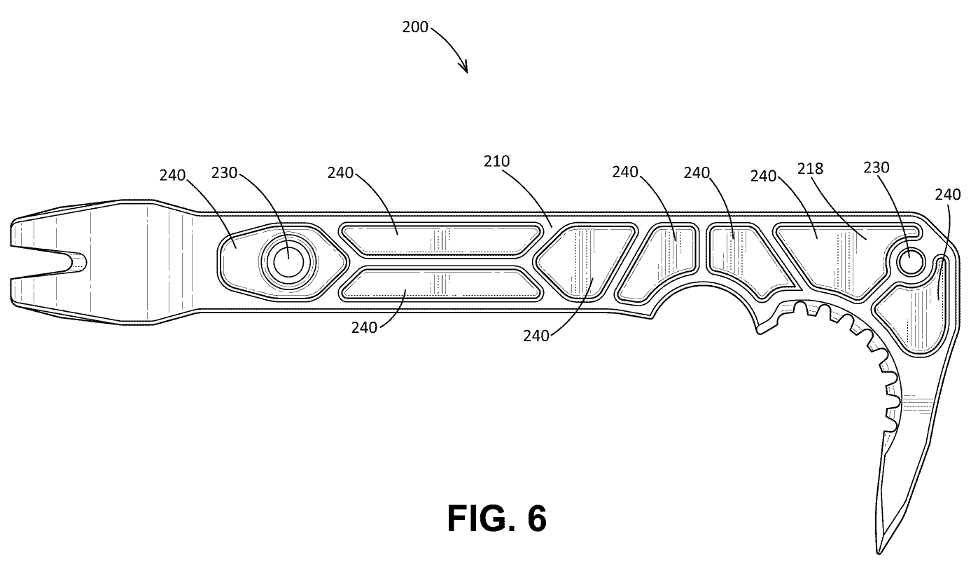

FIGS. 4–6 illustrate another multifunction pry bar 200 according to the principles of the present disclosure. The multifunction pry bar 200 is similar to the multifunction pry bar 100 discussed above, but the shank 210 and the head portion 218 include a plurality of lightening cutouts 240 configured to reduce the overall weight of the multifunction pry bar 200.

The lightening cutouts 240 may be positioned in low-stress regions of the multifunction pry bar 200 to reduce weight without significantly compromising structural integrity. In some implementations, the cutouts 240 may be shaped and/or arranged to serve secondary functions, such as enhancing grip or aesthetic appeal.

The multifunction pry bar 200 may also include two bores 230, each extending through the multifunction pry bar 200 to reduce weight. One of the bores 230 is located in the shank 210, and the other bore 230 is located in the head portion 218.

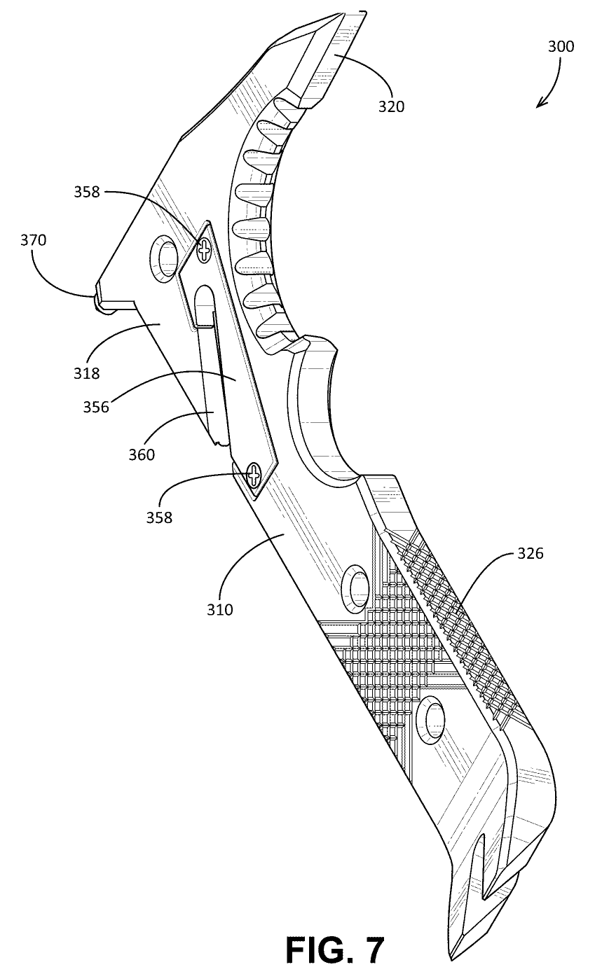

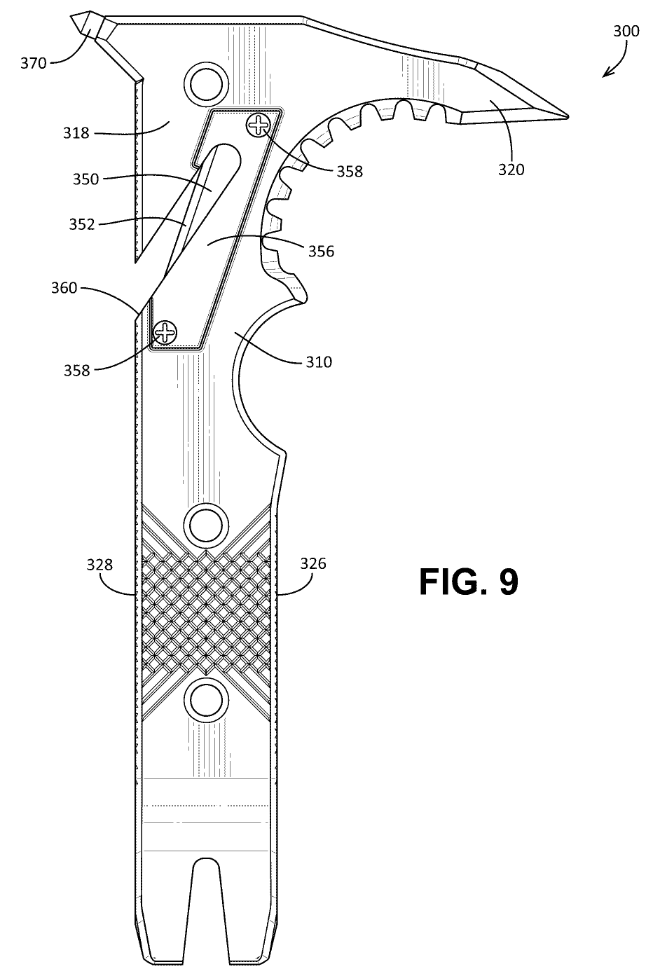

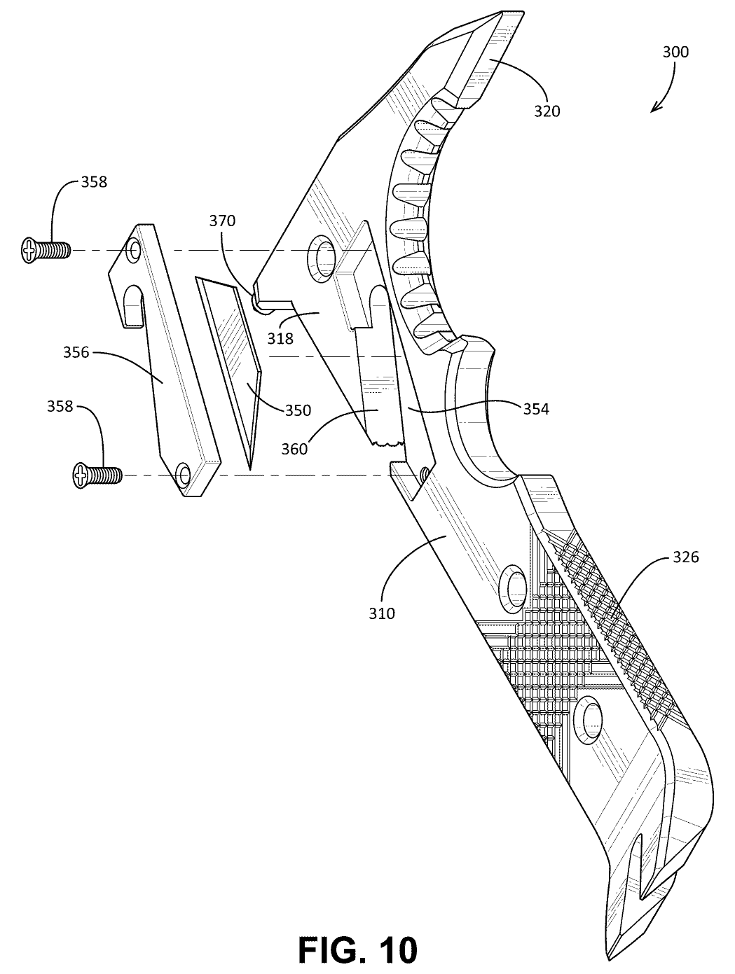

FIGS. 7–10 illustrate another multifunction pry bar 300 according to the principles of the present disclosure. The multifunction pry bar 300 is similar to the multifunction pry bars 100, 200 discussed above, but the multifunction pry bar 300 includes a cutting element 350. Additionally, the head portion 318 of the multifunction pry bar 300 includes a glass breaker 370 positioned on a rear side of the head portion 318 opposite the tapered pick 320.

The cutting element 350 of the multifunction pry bar 300 may be configured to cut material, such as a strap, cord, webbing, or tubing. In some implementations, the cutting element 350 is angled such that the shank 310 assists in applying force against an object to be cut. In some implementations, the edge 352 of the cutting element 350 is accessible through a slot 360 in the shank 310 of the multifunction pry bar 300. The slot 360 is elongated and configured to receive a portion of material and to direct the material toward the edge 352 of the cutting element 350. The edge 352 of the cutting element 350 is positioned within the slot 360 such that material received therein may be engaged and severed by the cutting element 350.

In some implementations, the cutting element 350 may be a blade (e.g., a trapezoidal utility blade) disposed in an opening 354 in a side of the multifunction pry bar 300. The blade may be retained within the opening 354 by a cover 356. The cover 356 may be secured in position by one or more fasteners 358, such as screws. In this way, the cutting element 350 may be replaced by removing the cover 356, replacing the blade, and re-securing the cover 356 in position using the provided fasteners 358. In some implementations, a removable blade is omitted, and the cutting element 350 may instead be defined by a sharpened edge of the slot 360.

The glass breaker 370 of the multifunction pry bar 300 is configured to shatter tempered glass upon impact. In some implementations, the glass breaker 370 may taper to a pointed tip configured to concentrate impact force for shattering glass. In some implementations, the glass breaker 370 is an integral portion of the multifunction pry bar 300. In other implementations, the glass breaker 370 may be formed from a hardened material (e.g., tungsten carbide or another suitable material) and press-fit into, or otherwise secured within, an opening in the head portion 318 of the multifunction pry bar 300.

In some implementations, the glass breaker 370 is disposed on a rear side of the head portion 318 opposite the tapered pick 320 and extends at an angle. In some implementations, the glass breaker 370 may extend at other angles and/or may be disposed elsewhere on the multifunction pry bar 300.

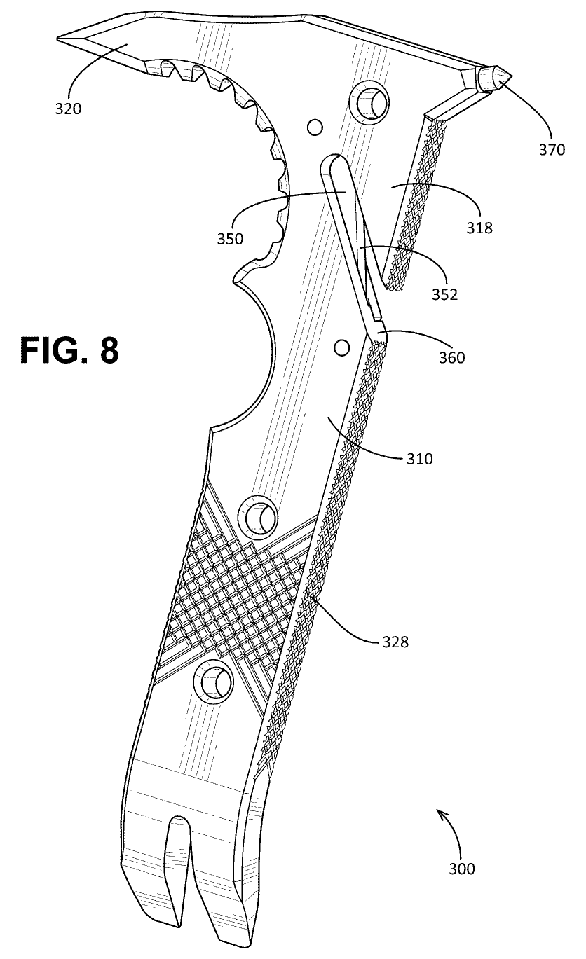

In some implementations, portions of the lateral side surfaces of the shank 310, in addition to the front edge 326 and the rear edge 328, may include knurling (see, e.g., FIGS. 7 and 8). The knurling is provided to improve grip during use.

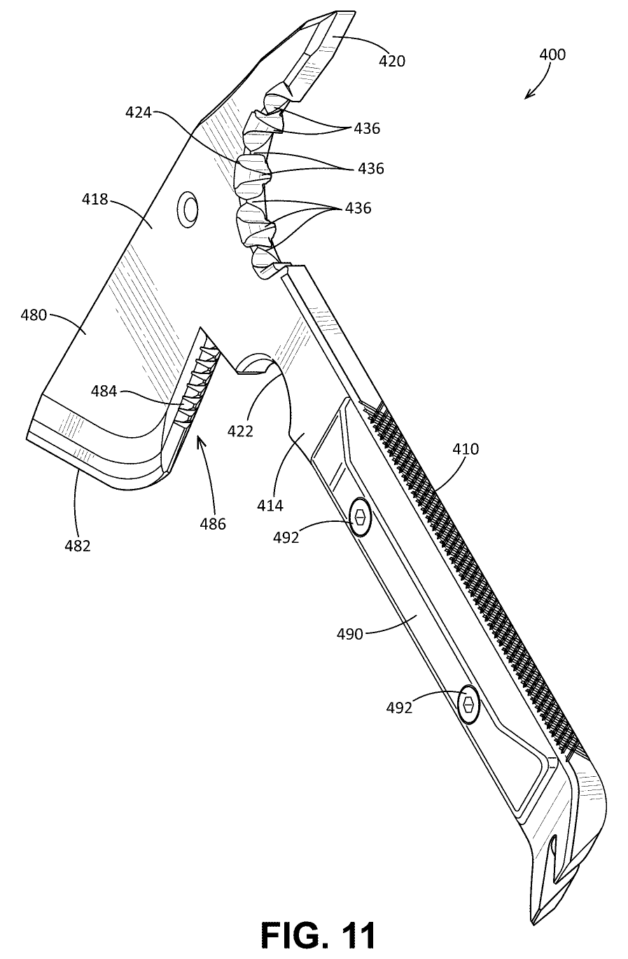

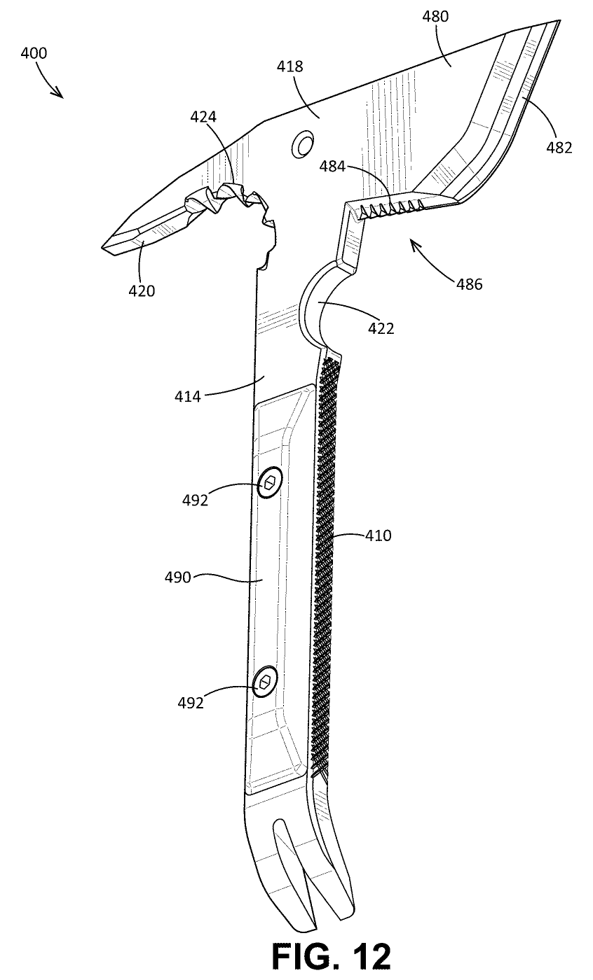

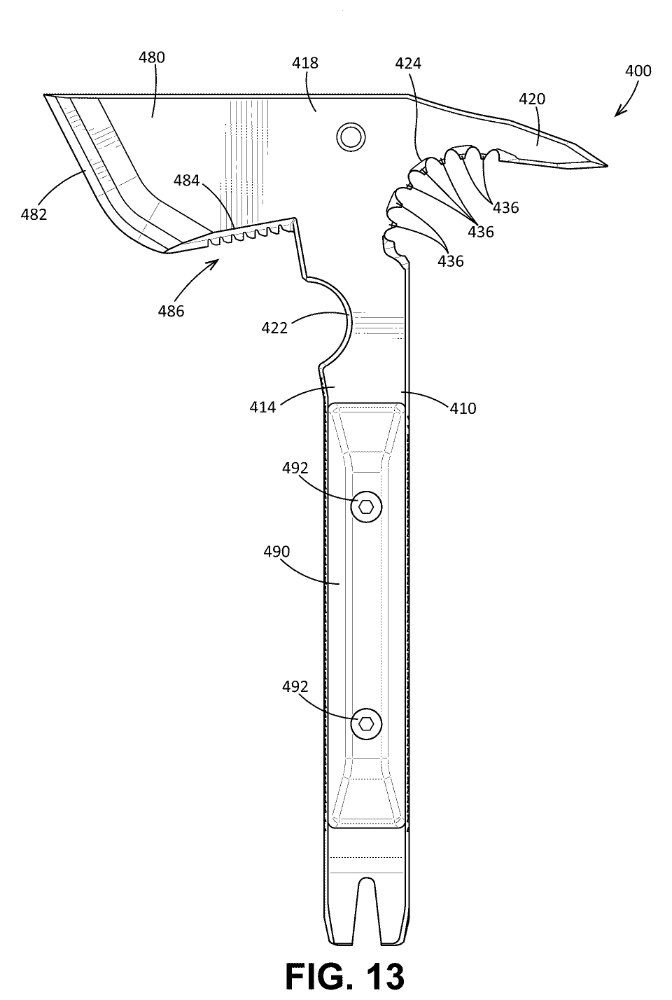

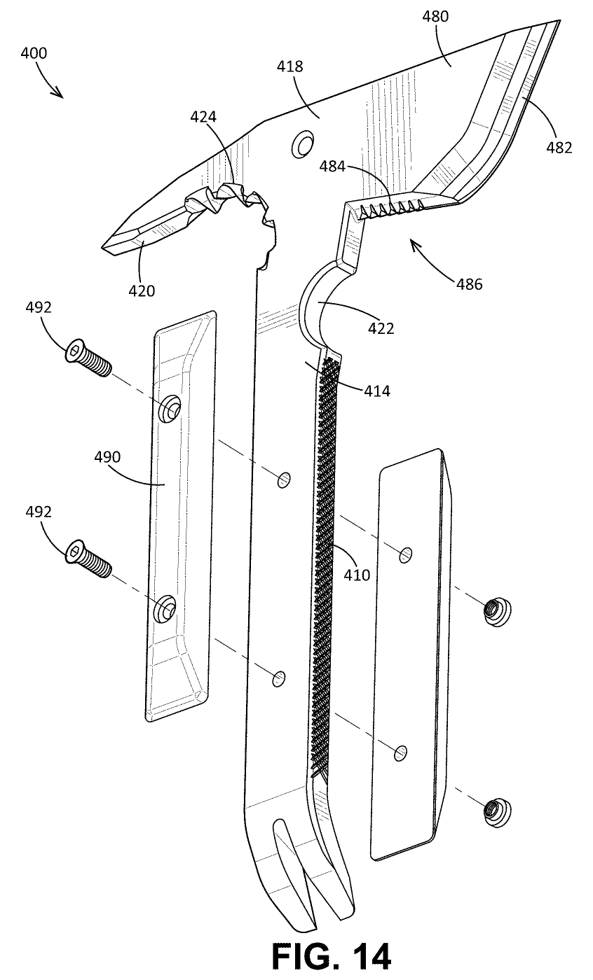

FIGS. 11–14 illustrate another multifunction pry bar 400 according to the principles of the present disclosure. The multifunction pry bar 400 is similar to the multifunction pry bars 100, 200, 300 discussed above, but the multifunction pry bar 400 includes an axe blade 480 positioned on a rear side of the head portion 418 opposite the tapered pick 420.

The axe blade 480 of the multifunction pry bar 400 may be configured for chopping, breaching, and cutting operations. In some implementations, the cutting edge 482 of the axe blade 480 may be blunt to reduce unintended contact-related injury during transport, storage, and use, while still permitting the axe blade 480 to perform impact, splitting, and wedging functions. However, in other implementations, the cutting edge 482 of the axe blade 480 may be sharpened.

In some implementations, the underside, or bottom edge, of the axe blade 480 may include a serrated cutting edge 484. The serrated cutting edge 484 may extend between an area adjacent to the shank 410 and an area adjacent to the cutting edge 482 of the axe blade 480. The serrations 486 may be configured to cut through materials such as drywall, wood, sheet metal, and other penetrable materials encountered during tactical and emergency operations. In this way, the serrated cutting edge 484 may be used to saw or tear through such materials during use and/or to ease withdrawal of the tool from a cut. The serrated cutting edge 484 may include seven serrations 486 defined by notches along the bottom edge of the axe blade 480. The number, spacing, and shape of the serrations 486 may vary in other implementations, depending on the desired cutting performance and material application.

In some implementations, a choil 422 may be positioned below the axe blade 480 of the multifunction pry bar 400. The choil 422 is a curved indentation formed in the head portion 418 adjacent to the second end 414 of the shank 410. The choil 422 may be shaped to receive a user’s index finger, thereby enhancing grip, control, and safety during manipulation of the multifunction pry bar 400. In some implementations, the choil 422 may also facilitate manufacturing of the multifunction pry bar 400.

In some implementations, the curved, serrated cutting edge 424 extending from the tapered pick 420 of the multifunction pry bar 400 may include serrations 436 arranged in a staggered configuration. The staggered configuration of the serrations 436 may enhance tearing and sawing performance when the multifunction pry bar 400 is used to cut through materials such as laminated glass, plastic, and fibrous composites. The number, spacing, and shape of the serrations 436 may vary in other implementations depending on the desired cutting performance and material application.

In some implementations, the shank 410 of the multifunction pry bar 400 may include a pair of grip panels 490 configured to improve grip during use. In some implementations, the grip panels 490 may include textured outer surfaces. The pair of grip panels 490 may include a first grip panel 490 and a second grip panel 490 secured to a first lateral side surface and a second lateral side surface, respectively, of the shank 410 (see, e.g., FIG. 11). The grip panels 490 may be secured to the shank 410 by one or more fasteners 492, such as Chicago screws. In some implementations, the grip panels 490 may be formed from G10 or another suitable material.

The foregoing description of the present disclosure is intended to be illustrative; it is not intended to be exhaustive or to limit the claims to the precise forms disclosed. Those skilled in the relevant art will appreciate that many modifications and variations are possible in light of the foregoing description and associated drawings.

Reference throughout this specification to an “embodiment,” “implementation,” or words of similar import indicates that a particular described feature, structure, or characteristic is included in at least one embodiment of the present disclosure. Thus, the phrase “in some implementations,” or a phrase of similar import, as used throughout this specification, does not necessarily refer to the same embodiment.

The described features, structures, or characteristics may be combined in any suitable manner in one or more embodiments. In the above description, numerous specific details are provided for a thorough understanding of embodiments of the present disclosure. One skilled in the relevant art will recognize, however, that embodiments of the present disclosure can be practiced without one or more of the specific details, or with other methods, components, materials, etc. In other instances, well-known structures, materials, or operations may not be shown or described in detail.

1. A tool comprising:
a shank having a first end and a second end;
a wedge portion extending from the first end of the shank; and
a head portion extending from the second end of the shank, the head portion including a tapered pick, a finger choil disposed adjacent to the second end of the shank, and a serrated cutting edge extending between the tapered pick and the finger choil.

2. The tool of claim 1, wherein the serrated cutting edge is curved.

3. The tool of claim 1, wherein the shank includes a front edge and a rear edge, and each of the front edge and the rear edge includes a knurled portion.

4. The tool of claim 1, wherein the shank and the wedge portion have substantially the same width.

5. The tool of claim 1, wherein the tapered pick terminates in a pointed tip.

6. The tool of claim 1, wherein the head portion includes a contact face positioned opposite the tapered pick.

7. The tool of claim 1, wherein the finger choil is a curved indentation.

8. The tool of claim 1, further comprising a plurality of lightening cutouts formed in at least one of the shank and the head portion.

9. The tool of claim 8, wherein the lightening cutouts are formed in both the shank and the head portion.

10. The tool of claim 1, further comprising at least one bore extending through at least one of the shank and the head portion.

11. The tool of claim 1, wherein the wedge portion includes a notch at a free end thereof.

12. The tool of claim 11, wherein the notch is generally V-shaped.

13. The tool of claim 1, wherein the wedge portion is angled away from a longitudinal axis of the shank.

14. The tool of claim 1, wherein the tool is formed as a single piece.

15. A tool comprising:
a shank having a first end and a second end;
a wedge portion extending from the first end of the shank;
a head portion extending from the second end of the shank, the head portion including a tapered pick, a finger choil disposed adjacent to the second end of the shank, and a serrated cutting edge extending between the tapered pick and the finger choil; and
a cutting element disposed in the shank.

16. The tool of claim 15, wherein the cutting element includes an edge accessible through a slot formed in the shank.

17. The tool of claim 15, further comprising a glass breaker disposed on the head portion.

18. A tool comprising:
a shank having a first end and a second end;
a wedge portion extending from the first end of the shank; and
a head portion extending from the second end of the shank, the head portion including a tapered pick, an axe blade, and a first serrated cutting edge extending from the tapered pick toward the second end of the shank.

19. The tool of claim 18, wherein the first serrated cutting edge is curved.

20. The tool of claim 18, wherein the axe blade is positioned opposite the tapered pick.

21. The tool of claim 18, wherein the axe blade includes a cutting edge and a second serrated cutting edge disposed along an underside of the axe blade.

22. The tool of claim 21, wherein the cutting edge of the axe blade is blunt.

23. The tool of claim 21, wherein the second serrated cutting edge is configured to ease withdrawal of the tool from a cut.

24. The tool of claim 18, wherein the head portion further includes a choil.
